(19) United States
(12) Patent Application Publication
(10) Pub. No.: US 2024/0393637 A1
(43) Pub. Date: Nov. 28, 2024

(54) POLARIZER, DISPLAY PANEL, AND DISPLAY DEVICE

(71) Applicants: HUIZHOU CHINA STAR OPTOELECTRONICS DISPLAY CO., LTD., Huizhou, Guangdong (CN); TCL China Star Optoelectronics Technology Co., Ltd., Shenzhen, Guangdong (CN)

(72) Inventors: Weiheng YANG, Shenzhen, Guangdong (CN); Gang LIU, Shenzhen, Guangdong (CN); Wei WANG, Shenzhen, Guangdong (CN)

(21) Appl. No.: 17/642,993

(22) PCT Filed: Mar. 1, 2022
(86) PCT No.: PCT/CN2022/078624

§ 371 Date: Mar. 15, 2022

(30) Foreign Application Priority Data
Feb. 16, 2022 (CN) 202210140921.2

(51) Int. Cl. G02F 1/1335

(52) U.S. Cl. CPC G02F 1/133528; G02F 1/133502; G02F 2201/50

(57) ABSTRACT

A display panel including a polarizer and an anti-glare and anti-reflection layer. The anti-glare and anti-reflection layer includes a hardened layer, a first matte particle layer including a plurality of first matte particles, and a second matte particles layer including a plurality of second matte particles. The first matte particles and the second matte particles are dispersed in the hardened layer. The second matte particle layer is positioned between the first matte particle layer and the polarizer body. An average refractive index of the first matte particles is less than an average refractive index of the second matte particles.

### FIELD OF INVENTION

The present application relates to the field of anti-glare technology, and in particular, to a polarizer, a display panel, and a display device.

### BACKGROUND OF INVENTION

With rapid development of liquid crystal display technology, liquid crystal display screens have become the mainstream products in the display field from an application of small-sized mobile phone screens at the beginning to a wide application of large-sized computer and TV screens. Therefore, there are higher requirements on a picture quality and an environmental adaptability of the display.

As far as the traditional LCD screen is concerned, a phenomenon of “glare” generally exists in an application process. This is because in the case of strong external ambient light, the display without anti-glare treatment will have specular reflection, so that the human eye can feel a strong reflected light, resulting in a “glare” reaction. In fact, the reflection of external ambient light will not only cause “glare” problems, but also lead to insufficient blackness of the display, resulting in a decrease in contrast performance that seriously affects the display effect. In addition, the reflected light and a red, a green, and a blue monochromatic light emitted by the original display have a mixed effect, resulting in a color deviation phenomenon, which directly affects a quality of the displayed image. In order to solve these series of problems, anti-glare film is invented. However, the currently anti-glare films still have certain defects in improving a quality of displayed pictures.

The currently anti-glare films still have certain defects in improving the quality of display pictures.

### SUMMARY OF INVENTION

In view of above-mentioned, the present application provides a polarizer, which can improve a haze of the product and reduce a reflectivity of the product, to improve a quality of the display image.

The present application also provides a display panel including the polarizer and a display device including the display panel.

For solving the above-mentioned problems, the technical solutions provided by the present application are as follows:

In a first aspect, the present application provides a display panel, including a display substrate and a polarizer formed on the display substrate, wherein the polarizer includes a polarizer body and an anti-glare and anti-reflection layer formed on the polarizer body, and wherein the anti-glare and anti-reflection layer includes:

a hardened layer;
a first matte particle layer including a plurality of first matte particles; and
a second matte particle layer including a plurality of second matte particles;
wherein the first matte particles and the second matte particles are dispersed in the hardened layer; and
wherein the second matte particle layer is positioned between the first matte particle layer and the polarizer body, and wherein an average refractive index of the first matte particles is less than an average refractive index of the second matte particles.

In one optional embodiment of the present application, a part of the first matte particles is positioned in the hardened layer, and another part of the first matte particles is protruded from a surface of the hardened layer away from the polarizer body, to form a rough surface on the surface of the hardened layer away from the polarizer body.

In one optional embodiment of the present application, a surface tension of the first matte particle is less than a surface tension of the second matte particle.

In one optional embodiment of the present application, a surface of the first matte particle grafts a fluorine-containing silane coupling agent.

In one optional embodiment of the present application, a surface of the second matte particle grafts a silane coupling agent.

In one optional embodiment of the present application, the first matte particle is a solid matte particle, a hollow matte particle or a mesoporous matte particle.

In one optional embodiment of the present application, an outer surface of the first matte particle is a smooth surface or an irregular surface.

In one optional embodiment of the present application, the irregular surface of the outer surface of the first matte particle has a plurality of convex portions and a plurality of concave portions, and the convex portions and the concave portions are alternately arranged.

In one optional embodiment of the present application, each of the convex portions is a circular arc surface or at least two connected planes, and wherein terminals of two adjacent circular arc surfaces intersect to form the concave portion.

In one optional embodiment of the present application, a hollowness of the hollow matte particle ranges from 30% to 60%.

In one optional embodiment of the present application, the mesoporous matte particle has a pore with particle size ranges from 2 nm to 50 nm inside.

In one optional embodiment of the present application, a particle size of the first matte particle ranges from 40 nm to 65 nm, and a particle size of the second matte particle ranges from 10 nm to 50 nm.

In one optional embodiment of the present application, an average refractive index of the first matte particles ranges from 1.17 to 1.30, and an average refractive index of the second matte particles ranges from 1.65 to 1.85.

In one optional embodiment of the present application, a material of the hardened layer is a composite resin, and wherein the composite resin includes at least two different kinds of resins.

In one optional embodiment of the present application, a material of the hardened layer is an UV-curable resin.

In a second aspect, the present application provides a display device including a main body and the above-mentioned display panel disposed in the main body.

In a third aspect, the present application provides a polarizer, the polarizer including:
a polarizer body; and
the anti-glare and anti-reflection layer as described above, the anti-glare and anti-reflection layer is formed on the polarized body.

In the polarizer, the display panel, and the display device provided by the present application, 1) the anti-glare and anti-reflection layer in the polarizer includes a hardened layer, and wherein the first matte particles and second matte particles dispersed in the hardened layer, and wherein the refractive index of the first matte particle is less than the refractive index of the second matte particle. Based on an interference principle of reflected light, interference and cancellation will occur when light incident on the surfaces of the first matte particle and the second matte particle with different refractive indices, the reflectivity of the anti-glare and anti-reflection layer can be reduced, thereby improving the anti-reflection effect of the anti-glare and anti-reflection layer, and improving the picture quality of display of the display panel. 2) A part of the first matte particles of the anti-glare and anti-reflection layer are positioned in the hardened layer, and the other part of the first matte particles are protruded from the surface of the hardened layer away from the polarizer, to form a rough surface on the surface of the hardened layer away from the base material layer, the haze of the anti-glare and anti-reflection layer is improved, and light will be diffusely scattered on the surface of the anti-glare and anti-reflection layer, which can improve the anti-glare effect of the anti-glare and anti-reflection layer, thereby improving the picture quality of display of the display panel. 3) By introducing hollow Silica particles with irregular particle surface as the first matte particle, the subtle changes of the rough surface can be further strengthened to change an overall optical path, and the anti-glare effect of the anti-glare and anti-reflection layer can be further improved, thereby the picture quality of display of the display panel can be improved. 4) By treating the first matte particles with a fluorine-containing silane coupling agent, the surface tension of the particles can be reduced, which can make the particles float to the surface of the hardened layer and form a low-reflection layer, and can make the surface of the first matte particle has better compatibility with the hardened layer, to reduce a graininess on the surface of the anti-glare and anti-reflection layer. By treating the second matte particles with a silane coupling agent, the surface tension of the second matte particles can be increased, to make the second matte particles are precipitated to a bottom of the hardened layer to form a high refraction layer. In this way, it is beneficial to form the first matte particle layer and the second matte particle layer with different refractive indices and distinct layers in the hardened layer.

### DESCRIPTION OF FIGURES

In order to illustrate the technical solutions in the embodiments of the present application more clearly, the following briefly introduces the accompanying figures used in the description of the embodiments. Obviously, the accompanying figures in the following description are only some embodiments of the present application. For those skilled in the art, other figures can also be obtained from these figures without inventive steps.

FIG. 1 is a schematic block diagram of a display device according to one preferred embodiment of the present application.

FIG. 2 is a cross-sectional view of a display panel according to one preferred embodiment of the present application.

FIG. 3 is a cross-sectional view of a first matte particle provided by the present application.

FIG. 4 is a cross-sectional view of a second type of first matte particle provided by the present application.

FIG. 5 is a cross-sectional view of a third type of first matte particle provided by the present application.

FIG. 6 is a cross-sectional view of a fourth type of first matte particle provided by the present application.

FIG. 7 is a light path diagram of light on an anti-glare and anti-reflection layer provided by the present application.

### DETAILED DESCRIPTION OF EMBODIMENTS

The technical solutions in the embodiments of the present application will be clearly and completely described below with reference to the accompanying figures in the embodiments of the present application. Obviously, the described embodiments are only some, but not all embodiments of the present application. Based on the embodiments of the present application, all other embodiments obtained by those skilled in the art without inventive steps shall fall within a protection scope of the present application.

In a description of the present application, it should be understood that an orientation or positional relationship indicated by the terms “upper”, “lower”, etc. is based on the orientation or positional relationship shown in the accompanying figures, and is only for a convenience of describing the present application and simplifying the description. It is not intended to indicate or imply that the device or element referred to must have a particular orientation, be constructed and operate in a particular orientation, and therefore should not be construed as limiting the invention. In addition, the terms “first” and “second” are only used for descriptive purposes, and should not be construed as indicating or implying relative importance or implying a number of indicated technical features. Thus, features defined as “first”, “second” may expressly or implicitly include one or more of said features. In the description of the present application, “plurality” means two or more, unless expressly and specifically defined otherwise.

The present application may repeat reference numerals and/or reference letters in different implementations, such repetition is for a purpose of simplicity and clarity and does not indicate a relationship between the various implementations and/or arrangements discussed.

The array substrate, liquid crystal display panel, and display device provided by the present application will be described in detail below with reference to specific embodiments and accompanying figures.

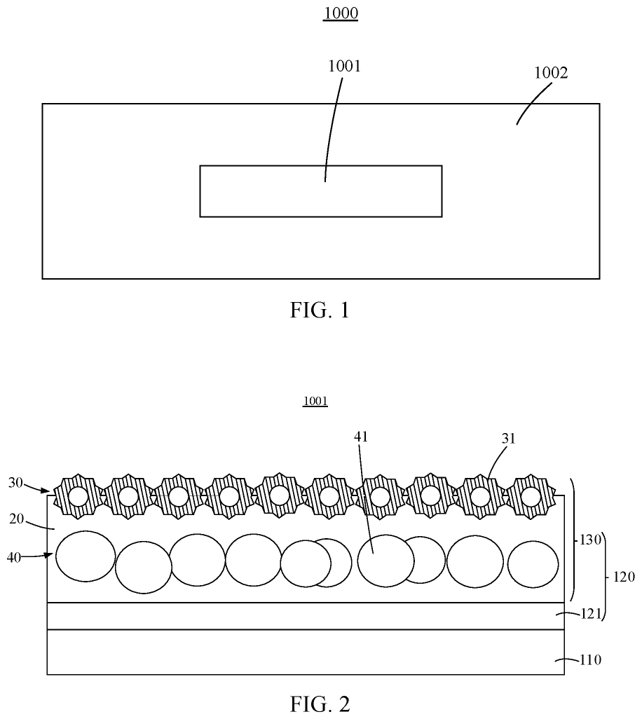

Referring to FIG. 1, the present application provides a display device 1000. The display device 1000 includes a display panel 1001 and a main body 1002, and the display panel 1001 is disposed in the main body 1002.

In this embodiment, the display device 1000 may be a display screen, a notebook, a computer, or the like. The display panel 1001 may be a liquid crystal display panel, an OLED display panel, an LED display panel, a Micro-LED display panel, a Mini-LED display panel, or the like.

Referring to FIG. 2, the display panel 1001 includes a display substrate 110 and a polarizer 120. The polarizer 120 is formed on the display substrate 110. The polarizer 120 includes a polarizer body 121 and an anti-glare and anti-reflection layer 130 formed on the polarizer body 121. The polarizer body 121 is located between the display substrate 110 and the anti-glare and anti-reflection layer 130.

In this embodiment, the display substrate 110 may be at least one of a liquid crystal display substrate, an OLED display substrate, an LED display substrate, a Micro-LED display substrate, a Mini-LED substrate, and the like.

In this embodiment, the polarizer body 121 includes a compensation film (not shown in the figure), a polarizer layer (not shown in the figure) and a protective layer (not shown in the figure). The compensation film is formed on the display substrate 110. The polarizer layer is formed on the compensation film. The protective layer is formed on the polarizer layer. The anti-glare and anti-reflection layer 130 is formed on the protective layer. The protective layer is a substrate of the anti-glare and anti-reflection layer 130. A material of the compensation film can be cyclo olefin polymer (COP), tri-cellulose acetate (TCA) and other materials. For example, the material of the compensation film can be COP material with trade name SANUQI, the TCA material with trade names PK3 and NR01, respectively. A material of the polarizer layer can be a material with a polarizing effect such as polyvinyl alcohol vinylalcohol polymer (PVA). A material of the protective layer can be TCA, polymethyl methacrylate (PMMA), polyethylene terephthalate (PET) and other materials.

In other embodiments, a structure of the polarizer 120 is not limited to the above structure, and can be adjusted according to actual conditions.

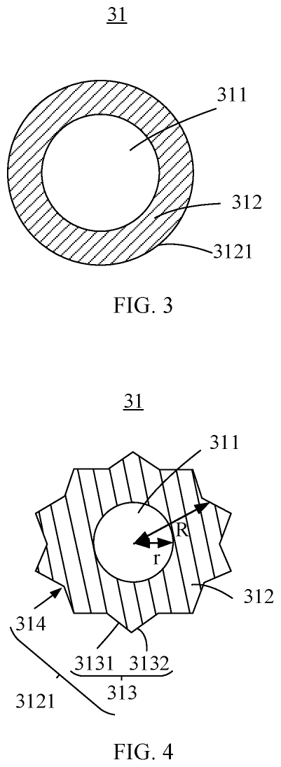

Referring to FIGS. 2 and 3 again, the anti-glare and anti-reflection layer 130 includes a hardened layer 20, a first matte particle layer 30, and a second matte particle layer 40. The first matte particle layer 30 includes a plurality of first matte particles 31, the second matte particle layer 40 includes a plurality of second matte particles 41, and the first matte particles 31 and the second matte particles 41 are dispersed in the hardened layer 20. The second matte particle layer 40 is positioned between the first matte particle layer 30 and the polarizer body 121, and an average refractive index of the first matte particles 31 is less than an average refractive index of the second matte particles 41.

In one optional embodiment of the present application, the average refractive index of the first matte particles 31 ranges from 1.17 to 1.30. The average refractive index of the second matte particles 41 ranges from 1.65 to 1.85.

Based on an interference principle of reflected light, interference and cancellation will occur when light incident on the surfaces of the first matte particles 31 and the second matte particles 41 with different refractive indices, which can reduce a reflectivity of the anti-glare and anti-reflection layer 130, thereby improving the anti-reflection effect of the anti-glare and anti-reflection layer 130, and improving the picture quality of display of the display panel 1001.

The first matte particles 31 and the second matte particles 41 can be pressed into the hardened layer 20 from opposite surfaces of the hardened layer 20 through processes such as embossing. It is also possible to improve the first matte particles 31 and the second matte particles 41 and disperse the first matte particles 31 and the second matte particles 41 in a material for making the hardened layer 20, and then formed the hardened layer 20 by coating or the like.

In one optional embodiment of the present application, a part of the first matte particles 31 is positioned in the hardened layer 20, and another part of the first matte particles 31 is protruded from a surface of the hardened layer 20 away from the polarizer 120, to form a rough surface on the surface of the hardened layer 20 away from the polarizer 120. The rough surface improves a haze of the anti-glare and anti-reflection layer 130, and the light will diffusely scatter on the surface of the anti-glare and anti-reflection layer 130, which can improve the anti-glare effect of the anti-glare and anti-reflection layer 130, thereby improving the picture quality of display of the display panel 1001.

In one optional embodiment of the present application, the first matte particles 31 in the first matte particle layer 30 are uniformly distributed and uniform in size, to make an overall anti-glare and anti-reflection effect of the anti-glare and anti-reflection layer 130 uniform, a phenomenon of strong local reflected light and strong glare can be avoid, and the picture quality of display of the display panel 1001 can be further improve improved.

In one optional embodiment of the present application, the first matte particles 31 are spherical.

In one optional embodiment of the present application, a height of the portion of the first matte particles 31 protruding from the surface of the hardened layer 20 away from the polarizer 120 is defined as H. H satisfies ⅔R≤H<2R, wherein R is a half of a particle size of the first matte particles 31. H satisfies ⅔R≤H<2R can make the anti-glare and anti-reflection layer 130 have better haze.

In one optional embodiment of the present application, a surface tension of the first matte particles 31 is less than a surface tension of the second matte particles 41. In this way, the first matte particles 31 can float up to a side of the hardened layer 20 away from the polarizer 120 and partially protrude from the hardened layer 20, and the second matte particles 41 can be precipitated to a side of the hardened layer 20 facing the polarizer 120, which is beneficial to form the first matte particle layer 30 and the second matte particle layer 40 with different refractive indices and distinct layers in the hardened layer 20.

In detail, in one optional embodiment of the present application, a surface of the first matte particle 31 is grafted with a fluorine-containing silane coupling agent, wherein the fluorine-containing silane coupling agent can reduce the surface tension of the first matte particles 31, which can make the first matte particles 31 float to the surface of the hardened layer 20 and form a low reflection layer, and can make the surface of the first matte particles 31 and the hardened layer 20 have better compatibility, to reduce a graininess of the film surface of the anti-glare and anti-reflection layer 130.

In one optional embodiment of the present application, the first matte particles 31 may be solid matte particles, hollow matte particles, mesoporous matte particles, or the like, wherein a refractive index of the solid matte particle is greater than an average refractive index of the hollow matte particles and greater than an average refractive index of the mesoporous matte particles.

In one optional embodiment of the present application, a hollowness of the hollow matte particle ranges from 30% to 60%, and the hollowness within this range is beneficial to a balance between the optical properties and the mechanical properties of the hollow matte particles.

In detail, the present application introduces a concept of hollowness to measure the hollowness and average refractive index of the hollow matte particles.

A calculation formula of the hollowness X of the hollow matte particle is: X=Vᵣ/V_{R}. Vᵣ=3πr³/4 is a hollow volume of the hollow matte particle. V_{R}=3πR³/4 is an overall volume of the hollow matte particle.

An average refractive index of the hollow matte particles is n=n₀X+n₁(1−X). X is a hollowness of the hollow matte particle, no is a refractive index of air, n₁ is a refractive index of the solid matte particle, 1.42≤n_{1≤1.46, 1.17}≤n₀≤1.30.

The hollow matte particles can be prepared by methods such as spray drying method, template synthesis method and the like.

In one optional embodiment of the present application, the mesoporous matte particle has a pore with particle size ranges from 2 nm to 50 nm inside.

In one optional embodiment of the present application, the particle size of the first matte particles 31 is in a nanometer scale. In detail, the particle size of the first matte particle 31 ranges from 40 nm to 65 nm. According to the currently research theory, when a particle size is less than 4 μm, a scattering intensity of the particle is better. Therefore, the particle size of the first matte particle 31 is set as above, ranges from 40 nm to 65 nm, to make all the first matte particles 31 have better scattering intensity, to make the anti-glare and anti-reflection effects of the anti-glare and anti-reflection layer 130 can be improved, thereby improving the picture quality of display of the display panel 1001.

Theoretically, a formula for calculating the reflectivity of the anti-glare and anti-reflection layer 130 is:

$$R = \frac{{{n}_{1}^{2} ( {n}_{0} - {n}_{2} )}^{2} - ( {n}_{0}^{2} - {n}_{1}^{2} ) ( {n}_{1}^{2} - {n}_{2}^{2} ) {sin}^{2} ( 2 π {n}_{1} d / λ )}{{{n}_{1}^{2} ( {n}_{0} + {n}_{2} )}^{2} - ( {n}_{0}^{2} - {n}_{1}^{2} ) ( {n}_{1}^{2} - {n}_{2}^{2} ) {sin}^{2} ( 2 π {n}_{1} d / λ )} …………… .$$

In the formula, R is a reflectivity, no is a refractive index of the medium where the incident light is located (the refractive index of air is 1), n₁ is a refractive index of the first layer (the first matte particles 31 of the present application), and n₂ is a refractive index of the second layer (the second matte particles 41 of the present application), d is the particle size of the first matte particles 31, and λ is a wavelength of incident light. After calculation, theoretically, when d satisfies the formula n₁d=kλ/4, the reflectivity of the first matte particle 31 is the least. The formula becomes:

$$R = {( \frac{{n}_{2} - {n}_{1}^{2}}{{n}_{2} + {n}_{1}^{2}} )}^{2} .$$

Therefore, when designing the particle size of the low-reflection layer structure (the first matte particles 130), it can be calculated based on this formula (n₁d=kλ)/4).

In detail, in one optional embodiment of the present application, the first matte particles 31 are matte particles with a low refractive index such as SiO₂. Further, the first matte particles 31 are solid SiO₂ particles, hollow SiO₂ particles, or mesoporous SiO₂ particles, or the like. Further more, the first matte particles 31 are solid SiO₂ particles or hollow SiO₂ particles or mesoporous SiO₂ particles, the surface of which is grafted with a fluorine-containing silane coupling agent.

Referring to FIG. 3, in one optional embodiment of the present application, the first matte particle 31 include a hollow part 311 and a solid part 312, and the hollow part 311 is positioned inside the solid part 312. The solid part 312 has an outer surface 3121 away from the hollow part 311.

In one optional embodiment of the present application, an outer surface 3121 of the first matte particles 31 are smooth surfaces.

In detail, in one optional embodiment of the present application, the outer surface 3121 of the first matte particle 31 is a circular or an elliptical surface.

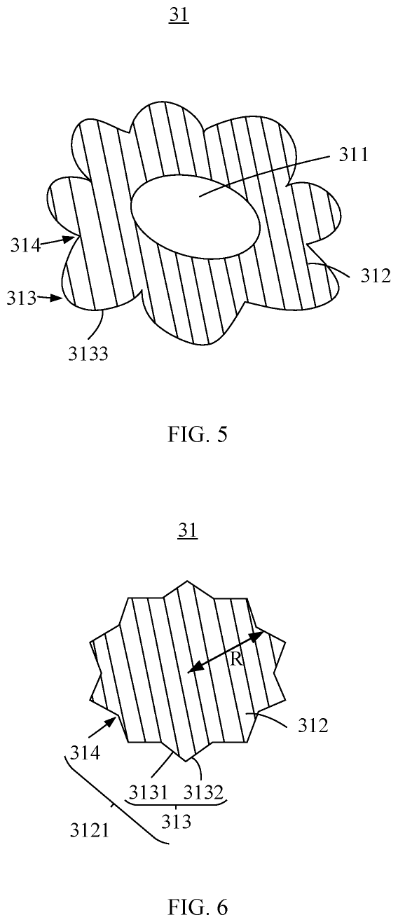

Referring to FIGS. 4 and 5, in one optional embodiment of the present application, the first matte particle 31 includes a hollow part 311 and a solid part 312, and the hollow part 311 is positioned inside the solid part 312. The solid part 312 has an outer surface 3121 away from the hollow part 31, in one optional embodiment of the present application, the outer surface 3121 of the first matte particle 31 is an irregular surface. The irregular outer surface 3121 of the solid part 312 includes a plurality of convex portions 313 and a plurality of concave portions 314, and wherein the convex portions 313 and the concave portions 314 are alternately arranged.

In one optional embodiment of the present application, the outer surface 3121 of the first matte particle 31 is irregular surface. By introducing hollow Silica particles with irregular particle surface as the first matte particle 31, the subtle changes of the rough surface can be further enhanced. When the external ambient light is incident, various diffuse reflections will occur on the irregular structure to change an overall optical path, thereby enhancing the haze on the surface of the hardened layer 20 to achieve the effect of the anti-glare film.

Referring to FIG. 4 again, in one optional embodiment of the present application, the convex portion 313 includes a first flat surface 3131 and a second flat surface 3132, and the first flat surface 3131 and the second flat surface 3132 are connected to form a tip horn. The first flat surface 3131 of one of the convex portions 313 is connected with the second flat surface 3132 of the other convex portion 313 adjacent thereto to form the concave portion 314.

Referring to FIG. 5 again, in one optional embodiment of the present application, the convex portion 313 includes a circular arc surface 3133, and wherein one terminal of two adjacent circular arc surfaces 3133 intersect to form the concave portion 314.

Referring to FIG. 6, in one optional embodiment of the present application, the first matte particles 31 are solid matte particles.

In one optional embodiment of the present application, the second matte particles 41 are metal oxide particles. In detail, the second matte particles 41 are metal oxide particles such as zinc oxide particles, titanium oxide particles, and tin oxide particles.

In one optional embodiment of the present application, the second matte particles 41 are nano-sized particles. In this embodiment, the second matte particles 41 are metal oxide nanoparticles such as zinc oxide nanoparticles, titanium oxide nanoparticles, and tin oxide nanoparticles. In detail, a refractive index of the zinc oxide particle is 1.9, a refractive index of the titanium oxide particles ranges from 2.1 to 2.3, and a refractive index of the tin oxide particles is 1.9.

In one optional embodiment of the present application, the particle size of the second matte particles 41 ranges from 10 nm to 50 nm.

In one optional embodiment of the present application, a surface of the second matte particle 41 is grafted with a silane coupling agent. A molecular structural formula of the silane coupling agent is generally YR—Si(OR)₃, wherein Y is an organic functional group, SiOR is a siloxy group, and wherein the siloxy group is reactive to inorganic substances, and wherein the organic functional group is reactive or compatible with organics. Therefore, when the silane coupling agent is interposed between the inorganic and organic interfaces, a bonding layer of organic matrix-silane coupling agent-inorganic matrix can be formed. Typical silane coupling agents includes Vinyltrimethoxysilane (A151), Silane,ethenyltrimethoxy (A171), Vinyl-tri-(β-methoxyethoxy)-silane (A172), and the like.

Treating the second matte particles 41 with a silane coupling agent can increase the surface tension of the second matte particles 41, so that the second matte particles 41 are precipitated to a bottom of the hardened layer 20 and form a high-refractive layer. Thus, which is beneficial to form the first matte particle layer 30 and the second matte particle layer 40 with different refractive indices and distinct layers in the hardened layer 20.

In one optional embodiment of the present application, a material of the hardened layer 20 is at least one of acrylic resin, polyvinyl chloride resin, water-based polyurethane resin, ultraviolet curing resin, and the like.

In another optional embodiment of the present application, the material of the hardened layer 20 is composite resin, and the composite resin includes at least two different kinds of resins.

In detail, the composite resin is a mixture of at least two of an acrylic resin, a polyvinyl chloride resin, a water-based polyurethane resin, and an UV-curable resin.

In this embodiment, the composite resin is the UV-curable resin.

By using composite resin as the material of the hardened layer 20, on the one hand, the anti-glare and anti-reflection layer 130 have a better matte effect, on the other hand, the hardened layer 20 made of composite resin has better hardness.

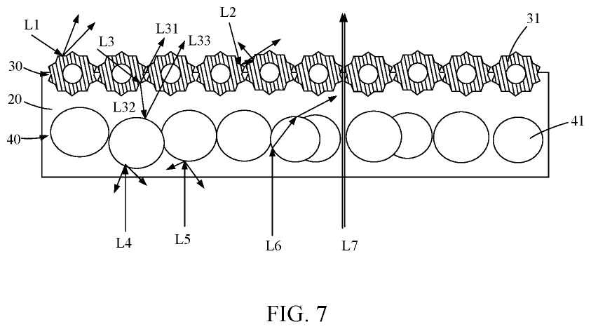

Referring to FIG. 7, when light L1 is incident on the first matte particles protruding from the hardened layer 20, part of the light L1 and L2 are diffusely reflected on the surface of the first matte particles 31. The anti-glare effect of the anti-glare and anti-reflection layer can be improved, thereby improving the picture quality of display of the display panel. Another part of the light L3 is refracted and reflected inside the second coating 223 to generate a first reflected light L31 and a refracted light L32. The refracted light L32 is incident on the surface of the second extinction particle 41 and is reflected on the surface of the second extinction particle 41 to generate a second reflected light L33. Based on the interference principle of reflected light: light incident on particles or coatings with different refractive indices will cause interference and cancellation. Because the refractive index of the first matte particles 31 provided by the present application is less than the refractive index of the second matte particles 41, interference and cancellation will occur between the first reflected light L31 and the second reflected light L33, so that the reflected light of the light L3 on the surface of the first matte particle 31 can be reduced, to reduce the reflectivity of the first matte particles 31, thereby improving the anti-reflection effect of the anti-glare and anti-reflection layer 130, to improve the picture quality of display of the display panel 1001. Part of the light L4 and L5 enter the hardened layer 20 and diffusely reflect on the surface of the second matte particles 41, and part of the light L5 enters the hardened layer 20 and is refracted multiple times on the inner surface of the second matte particles 41, which can disperse the light emitted by the display panel and has the effect of expanding the viewing angle. Part of the light L6 enters the hardened layer 20 and is refracted inside the second matte particles 41. Part of the light L7 passes through the hardened layer 20 from the gaps between the first matte particles 31 and the second matte particles 41.

In the anti-glare and anti-reflection layer, the polarizer, the display panel and the display device provided by the present application, 1) the anti-glare and anti-reflection layer in the polarizer includes a hardened layer, and wherein the first matte particles and second matte particles dispersed in the hardened layer, and wherein the refractive index of the first matte particle is less than the refractive index of the second matte particle. Based on an interference principle of reflected light, interference and cancellation will occur when light incident on the surfaces of the first matte particle and the second matte particle with different refractive indices, the reflectivity of the anti-glare and anti-reflection layer can be reduced, thereby improving the anti-reflection effect of the anti-glare and anti-reflection layer, and improving the picture quality of display of the display panel. 2) A part of the first matte particles of the anti-glare and anti-reflection layer are positioned in the hardened layer, and the other part of the first matte particles are protruded from the surface of the hardened layer away from the polarizer, to form a rough surface on the surface of the hardened layer away from the base material layer, the haze of the anti-glare and anti-reflection layer is improved, and light will be diffusely scattered on the surface of the anti-glare and anti-reflection layer, which can improve the anti-glare effect of the anti-glare and anti-reflection layer, thereby improving the picture quality of display of the display panel. 3) By introducing the irregular hollow silica on the particle surface as the first matte particle, the subtle changes of the rough surface can be further strengthened to change an overall optical path, and the anti-glare effect of the anti-glare and anti-reflection layer can be further improved, thereby the picture quality of display of the display panel can be improved. 4) By treating the first matte particles with a fluorine-containing silane coupling agent, the surface tension of the particles can be reduced, which can make the particles float to the surface of the hardened layer and form a low-reflection layer, and can make the surface of the first matte particle has better compatibility with the hardened layer, to reduce a graininess on the surface of the anti-glare and anti-reflection layer. By treating the second matte particles with a silane coupling agent, the surface tension of the second matte particles can be increased, to make the second matte particles are precipitated to a bottom of the hardened layer to form a high refraction layer. In this way, it is beneficial to form the first matte particle layer and the second matte particle layer with different refractive indices and distinct layers in the hardened layer.

To sum up, although the present application has been disclosed above with preferred embodiments, the above preferred embodiments are not intended to limit the present application. Those of ordinary skill in the art can make various Therefore, a protection scope of the present application is subject to a scope defined by the claims.

What is claimed is:

1. A display panel comprising a display substrate and a polarizer formed on the display substrate, wherein the polarizer comprises a polarizer body and an anti-glare and anti-reflection layer formed on the polarizer body, and wherein the anti-glare and anti-reflection layer comprises:
a hardened layer;
a first matte particle layer comprising a plurality of first matte particles; and
a second matte particle layer comprising a plurality of second matte particles;
wherein the first matte particles and the second matte particles are dispersed in the hardened layer; and
wherein the second matte particle layer is positioned between the first matte particle layer and the polarizer body, and wherein an average refractive index of the first matte particles is less than an average refractive index of the second matte particles.

2. The display panel according to claim 1, wherein a part of the first matte particles is positioned in the hardened layer, and another part of the first matte particles is protruded from a surface of the hardened layer away from the polarizer body to form a rough surface on the surface of the hardened layer away from the polarizer body.

3. The display panel according to claim 1, wherein a surface tension of the first matte particle is less than a surface tension of the second matte particle.

4. The display panel according to claim 3, wherein a surface of the first matte particle is grafted with a fluorine-containing silane coupling agent.

5. The display panel according to claim 3, wherein a surface of the second matte particle is grafted with a silane coupling agent.

6. The display panel according to claim 1, wherein the first matte particles is a solid matte particle, a hollow matte particle, or a mesoporous matte particle.

7. The display panel according to claim 6, wherein an outer surface of the first matte particle is a smooth surface or an irregular surface.

8. The display panel according to claim 7, wherein the irregular surface of the outer surface of the first matte particle has a plurality of convex portions and a plurality of concave portions, and the convex portions and the concave portions are alternately arranged.

9. The display panel according to claim 8, wherein each of the convex portions is a circular arc surface or at least two connected planes, and wherein terminals of two adjacent circular arc surfaces intersect to form the concave portion.

10. The display panel according to claim 6, wherein a hollowness of the hollow matte particle ranges from 30% to 60%.

11. The display panel according to claim 6, wherein the mesoporous matte particle has a pore with particle size ranges from 2 nm to 50 nm inside.

12. The display panel according to claim 1, wherein a particle size of the first matte particle ranges from 40 nm to 65 nm, and a particle size of the second matte particle ranges from 10 nm to 50 nm.

13. The display panel according to claim 1, wherein the average refractive index of the first matte particles ranges from 1.17 to 1.30, and the average refractive index of the second matte particles ranges from 1.65 to 1.85.

14. The display panel according to claim 1, wherein a material of the hardened layer is a composite resin, and wherein the composite resin comprises at least two different kinds of resins.

15. The display panel according to claim 14, wherein a material of the hardened layer is an UV-curable resin.

16. A display device, comprising a main body and a display panel disposed in the main body, wherein the display panel comprises a display substrate and a polarizer formed on the display substrate, wherein the polarizer comprises a polarizer body and an anti-glare and anti-reflection layer formed on the polarizer body, and wherein the anti-glare and anti-reflection layer comprises:
a hardened layer;
a first matte particle layer comprising a plurality of first matte particles; and
a second matte particle layer comprising a plurality of second matte particles;
wherein the first matte particles and the second matte particles are dispersed in the hardened layer; and
wherein the second matte particle layer is positioned between the first matte particle layer and the polarizer body, and wherein an average refractive index of the first matte particles is less than an average refractive index of the second matte particles.

17. A polarizer, comprising:
a polarizer body; and
an anti-glare and anti-reflection layer formed on the polarizer body, wherein the anti-glare and anti-reflection layer comprises:
a hardened layer;
a first matte particle layer comprising a plurality of first matte particles; and
a second matte particle layer comprising a plurality of second matte particles;
wherein the first matte particles and the second matte particles are dispersed in the hardened layer; and
wherein the second matte particle layer is positioned between the first matte particle layer and the polarizer body, and wherein the average refractive index of the first matte particles is less than the average refractive index of the second matte particles.

18. The polarizer according to claim 17, wherein a part of the first matte particles is positioned in the hardened layer, and another part of the first matte particles is protruded from a surface of the hardened layer away from the polarizer body, to form a rough surface on the surface of the hardened layer away from the polarizer body.

19. The polarizer according to claim 17, wherein a surface tension of the first matte particle is less than a surface tension of the second matte particle.

20. The polarizer according to claim 19, wherein a surface of the first matte particle is grafted a fluorine-containing silane coupling agent, and wherein a surface of the second matte particle is grafted a silane coupling agent.
